(19) United States
(12) Patent Application Publication
(10) Pub. No.: US 2023/0301284 A1
(43) Pub. Date: Sep. 28, 2023

(54) FISHING LURE AND METHOD OF SETTING A TRAVEL DEPTH OF THE FISHING LURE

(71) Applicant: Ocean Lures USA Corporation, Opa Locka, FL (US)

(72) Inventors: Carlos M. Ruiz, Miramar, FL (US); Ernesto Labrada, Hialeah, FL (US)

(21) Appl. No.: 18/186,321

(22) Filed: Mar. 20, 2023

Related U.S. Application Data
(60) Provisional application No. 63/323,148, filed on Mar. 24, 2022.

(51) Int. Cl. A01K 85/00

(52) U.S. Cl. CPC A01K 85/1841

(57) ABSTRACT

A fishing lure has a lure body with first and second openings. A wing system is disposed within the first opening and is movable within the first opening. A fastener is moveable within the second opening and secures the wing system to the lure body. Because the wing system is movable in the first opening, the angle of attack of the wing is adjustable and the lure can be set for various depth levels without using additional equipment such as lead weights and or planners.

### CROSS-REFERENCE TO RELATED APPLICATION

This application claims the priority, under 35 U.S.C. § 119, of U.S. provisional patent No. 63/323,148, filed Mar. 24, 2022; the prior application is herewith incorporated by reference in its entirety.

### BACKGROUND OF THE INVENTION

The invention relates to a fishing lure. More specifically, to a fishing lure that has multiple-depth capability.

The sport of fishing requires a unique balance of art and science. Accordingly, manufacturers have designed many different colored and shaped fishing lures to provide a wide variety of lure options for different fishing conditions.

Typically, the feeding behavior of fish is highly dependent upon a number of variables such as the time of year, time of day, water temperature, and the amount of sunlight, to name a few. Depending upon the particular fish that the fisherman is endeavoring to catch, any one or a combination of any of the above variables may affect the location under the water's surface at which the fish will be most inclined to feed. Since it is often impossible to predict with any precision the depth that the fish are feeding on any particular day without experimenting first with different lures, the fisherman is often compelled out of necessity to bring on the excursion many different lures designed to operate at different water depths in the hope of finding that one lure which the fish will respond to.

Given the impracticality and inconvenience of having to bring many different lures, necessitating trial-and-error techniques, each trial of which requires cutting and re-attaching the fishing line, to find the lure that works, fishermen have long strived to provide a single lure with multiple-depth capability. Responsive thereto, a variety of adjustable-depth fishing lures have been developed in an attempt to solve the aforementioned problems. For example, U.S. Pat. No. 6,948,274 issued to Sharp discloses an adjustable-depth fishing lure 42 having a pair of pivotable fins 62, 63 held within a lure body 46 of the fishing lure 42. Because the fins 62, 63 are pivotable, the fin pitch is adjustable and the depth at which the lure operates can be changed. The pivotable fins 62, 63 are connected by a shaft 76 and the combination of the fins and the shaft define a first member which interacts with a second member 80. A first end of the second member 80 is connected to the shaft 76 of the first member. The second member 80 is influenced by a pitch control mechanism 75 which controls a pivoting of the second member 80. As an end of the second member 80 is connected to the first member, a pivoting the of the second member 80 causes the first member to also pivot. Therefore, as the pitch control mechanism 75, formed of a fastener 85 disposed in a threaded aperture 88, is actuated the pitch of the fins 62, 63 can be changed. Although this lure is adequate for its intended use, the fact that it has a three-part adjustment mechanism means it is complicated and more susceptible to failure and reduced effectiveness due to wear and tear over time.

### BRIEF SUMMARY OF THE INVENTION

A primary object of the invention of the instant application is to fulfill the above-mentioned need by the provision of an adjustable-depth fishing lure. A further primary object of the present invention is to provide such a fishing lure which is efficient, inexpensive, easy to use, does not require additional equipment such as lead weights and or planners to achieve and maintain the required depth, and is easy to manufacture. In addition, it is a primary object and feature of the instant invention to provide a fishing lure which is less prone to an accidental changing of the depth selection due to a fish strike or snagging of the lure on underwater debris. Finally, the lure skirt color arrangement (e.g. black on top and purple on the bottom) will be maintained because the lure head/wing design does not allow rotation of the lure about the longitudinal axis.

With the foregoing and other objects in view there is provided, in accordance with the invention, an adjustable depth fishing lure for catching fish at user-selected water depths. The fishing lure contains a lure body having a first opening and a second threaded aperture opening into the first opening. A wing system is disposed in the first opening and is movable within the first opening, the wing system adjustably setting a traveling depth of the fishing lure. A fastener is moveable within the second threaded aperture and extends into the wing system for fixing an angle of pitch of the wing system in relationship to the lure body.

Not only is the fishing lure adjustable for depths, but it can also be trolled at higher speeds without the need of trolling weights or planners because the unique wing system substitutes for trolling weights and/or planners.

In accordance with an added feature of the invention, the wing system has a first wing part and a second wing part, each of the first and second wing parts ends along a longitudinal extent with a wing tip. Each of the first and second wing parts has an elongated body with a curved wing portion and a straight wing portion that meet and define the wing tip.

In accordance with another feature of the invention, the wing system has a first wing part and a second wing part, each of the first and second wing parts end along a longitudinal extent with a winglet.

In accordance with a further feature of the invention, the wing system has a middle portion with two supports, the two supports define a recess therebetween, and each of the first and second wing parts extends from one of the supports. The fastener extends into the recess and engages the middle portion for releasably fixing the wing system in place. Ideally, the wing system fits in the first opening with a frictional force and is rotatable within the first opening but requires a force to perform a rotational movement for overcoming the frictional force applied by the supports against the lure body.

In accordance with an additional feature of the invention, the first opening is a circular opening and the supports are cylindrical supports and are rotated against the lure body for adjusting the angle of pitch of the wing system.

In accordance with yet another feature of the invention, the lure body has a top portion with a recess formed therein, and a bridging ring with an eyelet extending across the recess, the eyelet provided for attaching to a fishing line. In addition, the lure body has another eyelet for attaching fishing hooks thereto.

In accordance with yet a further feature of the invention, a skirt having a plurality of strands and fishing hooks is attached to the lure body.

In accordance with another added feature of the invention, the lure body has a third threaded aperture and the skirt has a main skirt body with a through hole formed therein. A washer and a further fastener are disposed in the through hole and extend into and is threadedly engaged in the third threaded aperture.

In accordance with yet another additional feature of the invention, the wing system has a visual aid for assisting in determining the angle of pitch of the wing system in relationship to the lure body. Ideally, the wing system is manufactured as a one-piece part. For instance, the wing system is an injected molded part.

In accordance with another feature of the invention, the lure body is a buoyant rigid body. More specifically, the lure body is bullet shaped.

With the foregoing and other objects in view there is further provided, in accordance with the invention, an adjustable depth fishing lure for catching fish at user-selected water depths. The fishing lure has a lure body with a first opening and a second threaded aperture opening into the first opening. A wing system is disposed in the first opening and is movable within the first opening, the wing system adjustably sets a traveling depth of the fishing lure. A fastener is moveable within the second threaded aperture and extends into the wing system for fixing an angle of pitch of the wing system in relationship to the lure body. A skirt is attached to the lure body and has fishing hooks. The wing system prevents the skirt and lure body from rotating about a longitudinal direction of the fishing lure.

With the foregoing and other objects in view there is additionally provided, in accordance with the invention, a method of setting a traveling depth of the above-described fishing lure. The method includes rotating the wing system disposed in the first opening of the lure body to a desired angle of pitch of the wing system; and tightening the fastener moveable within the second threaded aperture such that the fastener engages and fixes the wing system in relationship to the lure body.

In accordance with an added mode of the invention, the fastener is loosened so that the wing system is no longer fixed to the lure body and then the wing system is removed from the lure body. A new wing system is then inserted into the lure body, the new wing system has winglets. The fastener which is moveable within the second threaded aperture is tightened such that the fastener engages and fixes the new wing system in relationship to the lure body.

Although the invention is illustrated and described herein as embodied in a fishing lure and a method of setting a travel depth of the fishing lure, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, exploded, top perspective view of a first embodiment of a fishing lure according to the invention;

FIG. 2 is a side view of the first embodiment of the fishing lure;

FIG. 3 is a bottom, plan view of the first embodiment of the fishing lure;

FIG. 4 is a sectional view of the first embodiment of the fishing lure taken along the line IV-IV shown in FIG. 3;

FIG. 5 is a schematic view of detail V shown in FIG. 3;

FIGS. 6 and 7 are perspective views of a wing system of the first embodiment;

FIG. 8 is a top view of the wing system of the first embodiment;

FIG. 9 is a front view of the wing system of the first embodiment;

FIG. 10 is an illustration showing an enlarged view of the winglet of the first embodiment;

FIG. 11 is another view of the winglet of the first embodiment;

FIG. 12 is a perspective view of a second embodiment of the wing system;

FIG. 13 is a perspective view of the second embodiment of the wing system;

FIG. 14 is a front view of the second embodiment of the wing system;

FIG. 15 is a top view of the second embodiment of the wing system;

FIG. 16 is an enlarged view of an end tip of the wing system;

FIG. 17 is a top view of a second embodiment of the fishing lure incorporating the second embodiment of the wing system;

FIG. 18 is a sectional view of the second embodiment of the fishing lure;

FIG. 19 is an exploded, perspective view of the second embodiment of the fishing lure;

FIG. 20 is a perspective view of the second embodiment of the fishing lure;

FIG. 21 is a perspective view of a second embodiment of the lure body;

FIG. 22 is a further perspective view of the second embodiment of the lure body;

FIG. 23 is bottom plan view of the second embodiment of the lure body;

FIG. 24 is a side view of the second embodiment of the lure body; and

FIG. 25 is a top plan view of the second embodiment of the lure body.

### DETAILED DESCRIPTION OF THE INVENTION

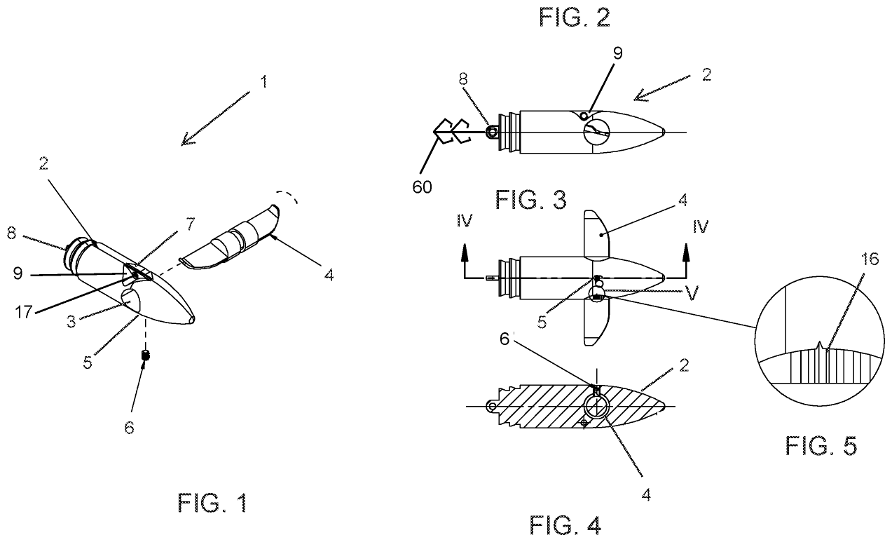

Referring now to the figures of the drawings in detail and first, particularly to FIG. 1 thereof, there is shown an exploded view of a fishing lure 1 formed of a lure body 2 having an opening 3 for receiving a pitch or angle adjustable wing system 4. Within the lure body 2 is a threaded aperture 5 (see also FIG. 3) for receiving or threading a fastener 6 such as a screw set for securing the wing system 4 in place in the lure body 2. The lure body 2 further has a recessed area 9 formed on a top portion of the lure body 2. An attachment ring or bridging ring 7 with an eyelet 17 for attaching a fishing line extends across the recessed area 9. The lure body 2 further has a hook ring 8 for attaching a fishing hook 60. We note that multiple attachment rings for hooks along the lure body 2 are possible and the hook ring 8 and its positioning are merely illustrative. The lure body 2 is shown to be generally bulleted shaped and is made of a buoyant hard body such as metal, plastic, a composite material or any other buoyant material suitable for prolonged water use.

FIGS. 2 and 3 show views of the completely assembled fishing lure 1 with the pitch or angle adjustable wing system 4 installed within the lure body 2.

FIG. 4 is a sectional view showing the fastener 6 engaging into and holding the wing system 4 in place. We note that the fastener 6 is threaded in the threaded aperture 5 by a screwdriver, Allen wrench or similar tool and physically presses into the wing system 4 for holding it in place.

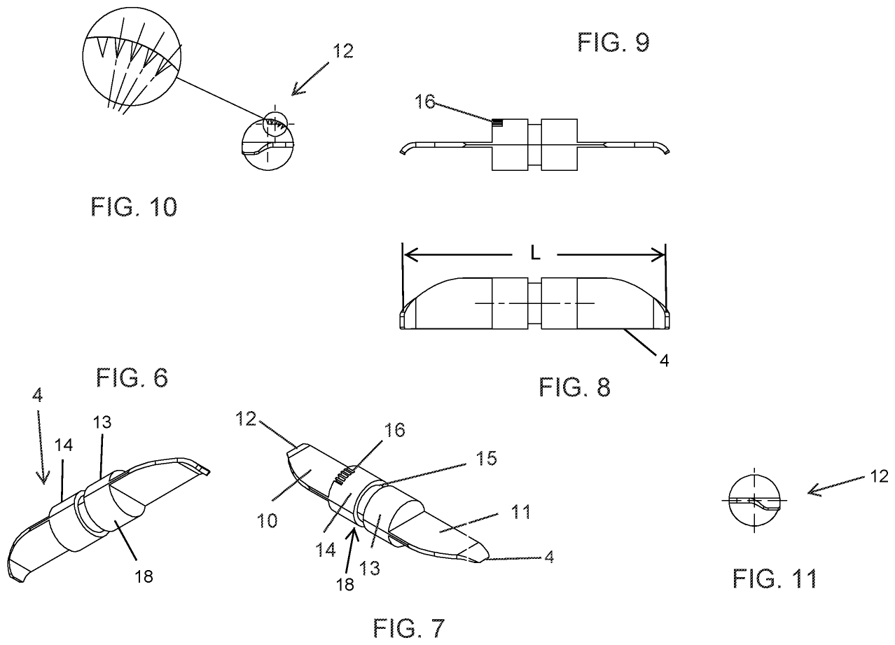

As best shown in FIGS. 6-11, the wing system 4 has a left-wing part 10 and a right-wing part 11 which both end in winglets 12. The wing parts 10, 11 are held in place and supported by a middle portion 18 formed of two cylindrical supports 13, 14. The two cylindrical supports 13, 14 define a recess 15 therebetween in which the fastener 6 engages the wing system 4. The cylinder supports 13, 14 are dimensioned to tightly fit within the circular opening 3 of the lure body 2. Ideally, there is a bit of a friction fit between the cylindrical supports 13, 14 and the circular opening 3 such that the cylindrical supports 13, 14 can be rotated within the circular opening 3 but requiring some force to perform the rotational movement of the cylindrical supports 13, 14.

As is best shown in FIGS. 3, 5, 7 and 9, one of the cylindrical supports 13, 14 has a visual aid 16 for assisting in determining the angle set on the wing system 4.

In operation, the user of the fishing lure 1, releases or loosens the fastener 6 from the wing system 4. The wing system 4 is then rotated to the desired angled position with the help of the visual aid 16. Then the fastener 6 is once again rotated to a tightened position via the use of a screwdriver or similar tool. Additionally, the attachment point 7, 17 of where the lead wire for the fishing line is placed and aligned with the trailing edge of the system wing 4 helps to control and maintain lure depth.

Thus, the fishing lure 1 is capability of traveling at different depths below a surface of a body of water in dependence on the angle selected for the wing system 4. A typical lure body 2 has a set buoyancy dependent on its shape, size and material selection, lure line length, trolling speed and of course on the type and number of fishhooks 60 attached to the lure body 2. The wing parts 10, 11 function as an airfoil and must overcome the buoyancy of the lure body 2 in order for the fishing lure to 1 dive under the water. In operation, as the fishing lure 1 is being pulled through the water, water impinges upon the wing parts 10, 11 thereby creating a pressure gradient with the greatest pressure being observed at the portion of the wing parts 10, 11 being directly impacted by the water. As the speed of the pull increases, a point is reached in which the water pressure acting on the wing parts 10, 11 overcomes the buoyant force of the lure body 2 and the fishing lure 1 is forced under the water's surface. As is well known by those skilled in the fluid dynamic arts, one factor which affects the depth at which the fishing lure 1 will dive beneath the water's surface is the magnitude of the force of the water impinging upon the wing parts 10, 11. The magnitude of this water pressure or force, in turn, is also dependent on a number of variables which, to name a few, include the speed in which the fishing lure 1 is moved through the water, surface area of the wing parts 10, 11, the angulation of the winglets 12, and the angle of attack of the wing parts 10, 11 (e.g., the degree of downward pitch of the wing parts 10, 11 from horizontal). It follows that by providing the fishing lure 1 with adjustable wing parts 10, 11, multiple angles of attack are possible, thus the fishing lure 1 is capable of traveling at different depths below the water's surface. Ideally, the length L of the wing system 4 is between 2-8 inches depending on the need to overcome the buoyancy the fishing lure. More particularly the wing has a length of 3-5 inches, and ideally 4 inches+/−0.1 inches. However, it is noted that wing systems larger than 8 inches are possible.

In addition, to the wing system 4, the placement and location of the attachment ring 7, 17 for attaching the fishing line also plays a role in the dynamic forces acting on the wing parts 10, 11.

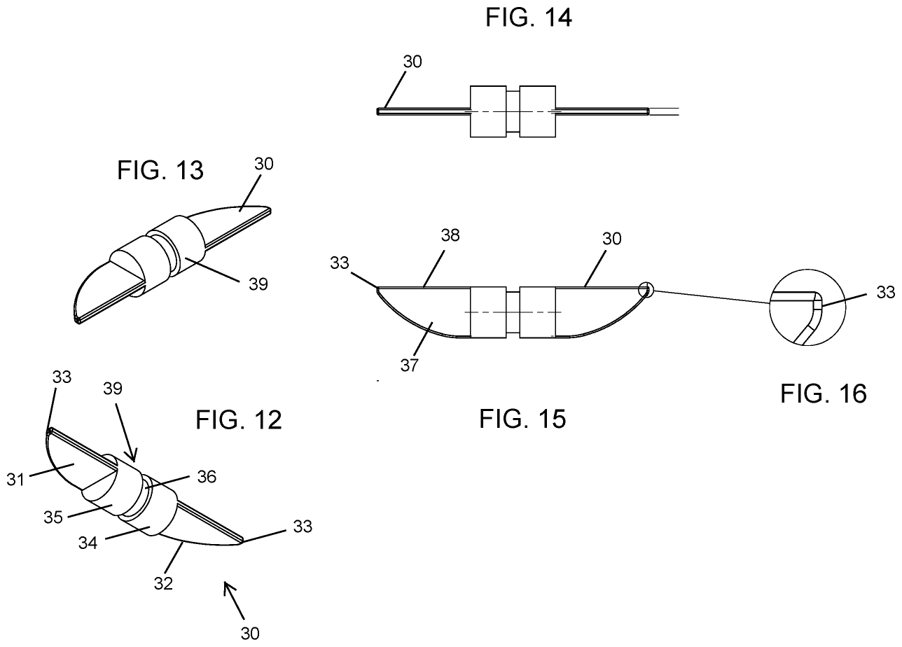

FIGS. 12-16 show a second embodiment of a second pitch or angle adjustable wing system 30. The second wing system 30 has a left-wing part 31 and a right-wing part 32 which are each formed of a curved wing portion or edge 37 and a straight wing portion or edge 38. The curved wing portion 37 and the straight wing portion 38 meet at an end and define a wing tip 33 rather than the winglets 12 shown in the first embodiment. The wing tips 33, as shown best in FIG. 16, are partially rounded at their ends. The wing parts 31, 32 are held in place and supported by a middle portion 39 formed from two cylindrical supports 34, 35. The two cylindrical supports 34, 35 define a recess 36 therebetween in which the fastener 6 engages the wing system 30. The cylinder supports 34, 35 are dimensioned to tightly fit within the circular opening 3 of the lure body 2. Ideally, there is a bit of a friction fit between the cylindrical supports 34, 35 and the circular opening 3 such that the cylindrical supports 34, 35 can be rotated within the circular opening 3 but requiring some force to perform the rotational movement of the cylindrical supports 34, 35.

The main difference between the two wing systems 4, 30 is that the first wing system 4 ends in winglets 12 while the second wing system 30 ends with rounded wing end tips 33. FIG. 16 shows an enlarged view of the wing end tip 33 showing a more precise partially rounded contour. Although there are minor performance differences between the winglet 12 and wing tip 33 designs, the partially rounded end tip 33 is easier to manufacture.

As with the first wing system 4, the second wing system 30 may also contain the visual aid 16 on one of the cylindrical supports 34, 35 for assisting in determining the angle set on the second wing system 30 (see FIGS. 3, 5, 7 and 9 for the visual aid 16). Ideally, the first and second wing systems 4, 30 are made as unitary or one-piece parts. For example, the wing systems 4, 30 are injected molded parts but can made from other materials such as metal, composites or wood.

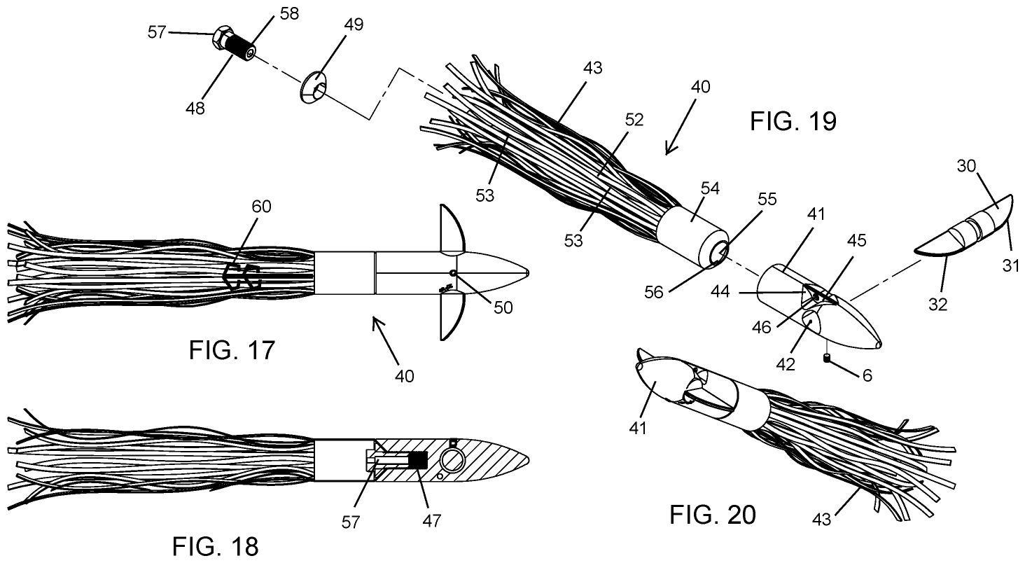

FIGS. 17-25 show a second embodiment of a second fishing lure 40 having a second lure body 41 with an opening 42 in which the second wing system 30 is held. Attached to the second lure body 41 is a skirt 43. The second lure body 41 has a recessed area 44 formed on a top portion of the second lure body 41. An attachment ring 45 with an eyelet 46 for attaching a fishing line extends across the recessed area 44. The second lure body 41 in a rear area has an internal threading 47 formed therein, see FIGS. 18 and 25.

As best shown in FIG. 19, the skirt 43 is attached to the second lure body 41 by means of a fastener (bolt) 48 and a washer 49. The bolt 48 engages the internal threading 47 of the second lure body 41. More specifically, the skirt 43 has a main skirt body 54 with a through hole 55 running through the main skirt body 54. The washer 49 sits inside the main skirt body 54 at an exit point 56 of the through hole 55 aligned with the internal threading 47. A head 57 of the bolt 48 is housed in the washer 49 and threads 58 of the bolt 48 engage the internal threading 47 of the second lure body 41.

A further fastener 50 engages into a further threaded aperture 51 of the second lure body 40 for holding the second wing system 30 in place within the second lure body 40. At this point, it should be clear that the first and second wing systems 4, 40 are interchangeable in the first and second lure bodies 2, 41.

The skirt 43 is formed from a plurality of strands 52 and hidden within the strands 52 are hooks 60. The strands 52 maybe of various colorings depending on the type of fishing lure 40 desired. Finally, the lure skirt color arrangement (e.g. black on top and purple on the bottom) will be maintained because the lure head/wing design does not allow rotation of the fishing lure about its longitudinal axis.

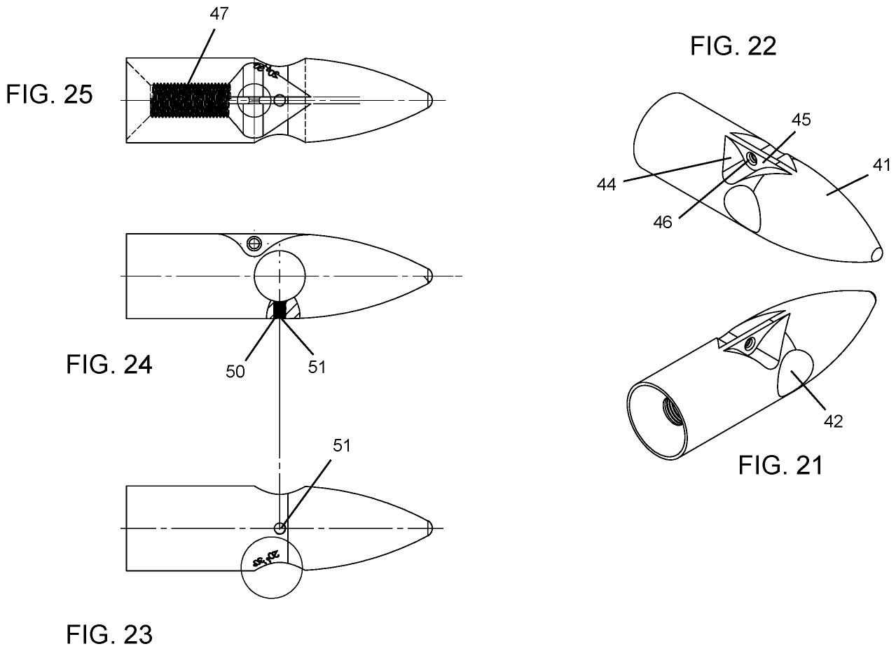

FIGS. 21-25 show more precise views of the second lure body 41.

Not only is the fishing lure adjustable for depths because of the unique wing system 4, 30, but the wing system 4, 30 also allows the fishing lure to be trolled at higher speeds without the need of trolling weights or planners. In other words, a fisherman can carry less equipment as the wing system also substitutes for and/or provides the function of trolling weights and/or planners.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

1. An adjustable depth fishing lure for catching fish at user-selected water depths, comprising:
a lure body having a first opening formed therein and a second threaded aperture formed therein and opening into said first opening;
a wing system disposed in said first opening and being movable within said first opening, said wing system adjustably setting a traveling depth of the fishing lure; and
a fastener moveable within said second threaded aperture and extending into said wing system for fixing an angle of pitch of said wing system in relationship to said lure body.

2. The adjustable depth fishing lure according to claim 1, wherein said wing system has a first wing part and a second wing part, each of said first and second wing parts ends along a longitudinal extent with a wing tip.

3. The adjustable depth fishing lure according to claim 2, wherein each of said first and second wing parts has an elongated body with a curved wing portion and a straight wing portion that meet and define said wing tip.

4. The adjustable depth fishing lure according to claim 1, wherein said wing system has a first wing part and a second wing par, each of said first and second wing parts end along a longitudinal extent with a winglet.

5. The adjustable depth fishing lure according to claim 2, wherein said wing system has a middle portion with two supports, said two supports define a recess therebetween, each of said first and second wing parts extends from one of said supports.

6. The adjustable depth fishing lure according to claim 5, wherein said fastener extends into said recess and engages said middle portion for releasably fixing said wing system in place.

7. The adjustable depth fishing lure according to claim 5, wherein said wing system fits in said first opening with a frictional force and is rotatable within said first opening but requires a force to perform a rotational movement for overcoming the frictional force applied by said supports against said lure body.

8. The adjustable depth fishing lure according to claim 7, wherein:
said first opening is a circular opening; and
said supports are cylindrical supports and are rotated against said lure body for adjusting the angle of pitch of said wing system.

9. The adjustable depth fishing lure according to claim 1, wherein:
said lure body has a top portion with a recess formed therein; and
said lure body has a bridging ring with an eyelet extending across said recess, said eyelet provided for attaching to a fishing line.

10. The adjustable depth fishing lure according to claim 1, wherein said lure body has an eyelet for attaching fishing hooks thereto.

11. The adjustable depth fishing lure according to claim 1, further comprising a skirt having a plurality of strands and fishing hooks, said skirt is attached to said lure body.

12. The adjustable depth fishing lure according to claim 11,
wherein said lure body has a third threaded aperture formed therein;
further comprising a further fastener and washer; and
wherein said skirt has a main skirt body with a through hole formed therein, said washer and said further fastener disposed in said through hole and extending into and threadedly engaged in said third threaded aperture.

13. The adjustable depth fishing lure according to claim 1, wherein said wing system has a visual aid for assisting in determining the angle of pitch of said wing system in relationship to said lure body.

14. The adjustable depth fishing lure according to claim 1, wherein said wing system is a one-piece part.

15. The adjustable depth fishing lure according to claim 1, wherein said wing system is an injected molded part.

16. The adjustable depth fishing lure according to claim 1, wherein said lure body is a buoyant rigid body.

17. The adjustable depth fishing lure according to claim 1, wherein said lure body is bullet shaped.

18. An adjustable depth fishing lure for catching fish at user-selected water depths, comprising:
a lure body having a first opening formed therein and a second threaded aperture formed therein and opening into said first opening;
a wing system disposed in said first opening and being movable within said first opening, said wing system adjustably setting a traveling depth of the fishing lure;
a fastener moveable within said second threaded aperture and extending into said wing system for fixing an angle of pitch of said wing system in relationship to said lure body; and
a skirt attached to said lure body and having fishing hooks, said wing system preventing said skirt and lure body from rotating about a longitudinal direction of the fishing lure.

19. A method of setting a traveling depth of a fishing lure according to claim 1, which comprises the steps of:
rotating the wing system disposed in the first opening of the lure body to a desired angle of pitch of the wing system; and
tightening the fastener moveable within the second threaded aperture such that the fastener engages and fixes the wing system in relationship to the lure body.

20. The method according to claim 19, which further comprises:
loosening the fastener so that the wing system is no longer fixed to the lure body;
removing the wing system from the lure body;
inserting a new wing system into the lure body, the new wing system having winglets;
tightening the fastener moveable within the second threaded aperture such that the fastener engages and fixes the new wing system in relationship to the lure body.
